(19) United States
(12) Patent Application Publication
(10) Pub. No.: US 2024/0406810 A1
(43) Pub. Date: Dec. 5, 2024

(54) MULTI-PANEL USER EQUIPMENT

(71) Applicant: Nokia Technologies Oy, Espoo (FI)

(72) Inventors: Alperen GUNDOGAN, Munich (DE); Christian ROM, Aalborg (DK); Samantha CAPORAL DEL BARRIO, Aalborg (DK); Ingo VIERING, Munich (DE)

(21) Appl. No.: 18/698,819

(22) PCT Filed: Oct. 13, 2021
(86) PCT No.: PCT/EP2021/078293

§ 371 Date: Apr. 5, 2024

(51) Int. Cl. H04W 36/00; H04W 36/30

(52) U.S. Cl. CPC H04W 36/0058; H04W 36/0016; H04W 36/304

(57) ABSTRACT

A multi-panel mobile apparatus may be configured to perform, periodically during a scan time, downlink quality measurements on a serving cell and on at least one neighboring cell; determine, in a first mode, a first distribution of a scan time between a plurality of antenna panels, based on measurement results of a serving antenna panel on the serving cell; determine, in a second mode, a second distribution of the scan time between a subset of the plurality of antenna panels, based on a first difference between measurement results on the serving cell and measurement results on one or more candidate target cells for a handover procedure; and determine, in a third mode, a third distribution of the scan time between a further subset of the plurality of antenna panels, based on a second difference between measurement results on the serving cell and measurement results on a target cell.

### TECHNICAL FIELD

Various example embodiments relate to wireless communications.

### BACKGROUND

Wireless communication systems are under constant development. One way to significantly increase the data rates and reliability of a wireless communication system is to use multi-antenna techniques. The performance is particularly improved if both a transmitting apparatus and a receiving apparatus are equipped with multiple antenna panels.

### SUMMARY

According to an aspect there is provided an apparatus comprising at least one processor; and at least one memory including computer program code, the at least one memory and computer program code configured to, with the at least one processor, cause the apparatus to at least: perform, periodically during a scan time, downlink quality measurements on a serving cell and on at least one neighboring cell; determine, in a first mode, a first distribution of the scan time between a plurality of antenna panels, based on measurement results of a serving antenna panel of the plurality of antenna panels, on the serving cell; determine, in a second mode, a second distribution of the scan time between a subset of the plurality of antenna panels, based on a first difference between measurement results on the serving cell and measurement results on one or more candidate target cells for a handover procedure; and determine, in a third mode, a third distribution of the scan time between a further subset of the plurality of antenna panels, based on a second difference between measurement results on the serving cell and measurement results on a target cell.

In an embodiment, the apparatus is in the first mode at least in response to a first condition being met, the apparatus is in the second mode in response to the first condition not being met, and the apparatus is in the third mode in response to a second condition being met.

In an embodiment, the first condition is met in response to a third difference between measurement results on the serving cell and on neighboring cells being equal to or above a first threshold, the first threshold being higher than or equal to a threshold sufficient for initiating the handover procedure.

In embodiments, the second condition is met at least in response to: receiving information that the target cell is prepared for the handover; the second difference is below a second threshold, which is equal to or smaller than the first threshold; and the serving cell is usable for uplink and downlink data transmissions.

In embodiments, the at least one memory and computer program code are configured to, with the at least one processor, further cause the apparatus to at least: switch from the second mode to the first mode in response to the handover procedure having been initiated.

In embodiments, the at least one memory and computer program code are configured to, with the at least one processor, further cause the apparatus to at least: remain in the first mode after switching at least until receiving from the wireless network information indicating that one or more target cells are prepared, wherein the first threshold is higher than the threshold causing the handover to be initiated.

In embodiments, the at least one memory and computer program code are configured to, with the at least one processor, further cause the apparatus to at least: remain in the first mode after receiving the information indicating that one or more target cells are prepared until the third difference is below the second threshold; and switch from the first mode to the third mode in response to the third difference being below the second threshold, wherein the first threshold is higher than the second threshold.

In embodiments, the at least one memory and computer program code are configured to, with the at least one processor, further cause the apparatus to at least: determine the first threshold and the second threshold using handover measurement configurations received from the wireless network.

In embodiments, the apparatus is configured to prioritize, in the first distribution, scan time of the serving antenna panel over the other antenna panels in response to the measured downlink quality of the serving cell being higher than the measured downlink quality of neighboring cells; prioritize, in the second distribution, scan time of antenna panels, which provide best measurement results on one or more candidate target cells; and prioritize, in the third distribution, scanning by an antenna panel providing best measurement results on the target cell.

In embodiments, the apparatus is configured to, in the first distribution, allocate from at least 50 percent to 100 percent of the scan time to the serving antenna panel.

In embodiments, the apparatus is configured to, in the second distribution, allocate from at least 5 percent to at most 50 percent of the scan time to the serving antenna panel.

In embodiments, the apparatus is configured to, in the third distribution, allocate from at least 5 percent to at most 50 percent of the scan time to the serving antenna panel.

In embodiments, the at least one memory and computer program code are configured to, with the at least one processor, further cause the apparatus to at least: associate in the first distribution two or more first distribution levels with corresponding first level thresholds; and determine, in the first mode, the first distribution of the scan time by comparing at least a measured downlink quality value with the first level thresholds, starting from the highest first level threshold, and determine the first distribution of the scan time to be a first distribution in the level whose level threshold is met.

In embodiments, the at least one memory and computer program code are configured to, with the at least one processor, further cause the apparatus to at least: associate in the second distribution two or more second distribution levels with corresponding second level thresholds; determine, in the second mode, the second distribution of the scan time by comparing a first difference calculated from measurement results with the second level thresholds, starting from the highest second level threshold; and determine the second distribution of the scan time to be a second distribution in the level whose level threshold is met.

In embodiments, the at least one memory and computer program code are configured to, with the at least one processor, further cause the apparatus to at least: associate in the third distribution two or more third distribution levels with corresponding third level thresholds; determine, in the third mode, the third distribution of the scan time by comparing a second difference calculated from the measurement results with the third level thresholds, starting from the highest third level threshold; and determine the third distribution of the scan time to be a third distribution in the level whose level threshold is met.

According to an aspect there is provided a method comprising: performing, periodically during a scan time, downlink quality measurements on a serving cell and on at least one neighboring cell; determining, in a first mode, a first distribution of the scan time between a plurality of antenna panels, based on measurement results of a serving antenna panel of the plurality of antenna panels, on the serving cell; determining, in a second mode, a second distribution of the scan time between a subset of the plurality of antenna panels, based on a first difference between measurement results on the serving cell and measurement results on one or more candidate target cells for a handover procedure; and determining, in a third mode, a third distribution of the scan time between a further subset of the plurality of antenna panels, based on a second difference between measurement results on the serving cell and measurement results on a target cell.

In an embodiment, the method further comprises: being in the first mode at least in response to a first condition being met; being in the second mode in response to the first condition not being met; and being in the third mode in response to a second condition being met.

In an embodiment, the method further comprises: meeting the first condition in response to a third difference between measurement results on the serving cell and on neighboring cells being equal to or above a first threshold, the first threshold being higher than or equal to a threshold sufficient for initiating the handover procedure.

In embodiments, the method further comprises meeting the second condition at least in response to: receiving information that the target cell is prepared for the handover; the second difference is below a second threshold, which is equal to or smaller than the first threshold; and the serving cell is usable for uplink and downlink data transmissions.

In embodiments, the method further comprises: switching from the second mode to the first mode in response to the handover procedure having been initiated.

In embodiments, the method further comprises: remaining in the first mode after switching at least until receiving from the wireless network information indicating that one or more target cells are prepared, wherein the first threshold is higher than the threshold causing the handover to be initiated.

In embodiments, the method further comprises: remaining in the first mode after receiving the information indicating that one or more target cells are prepared until the third difference is below the second threshold; and switching from the first mode to the third mode in response to the third difference being below the second threshold, wherein the first threshold is higher than the second threshold.

In embodiments, the method further comprises: determining the first threshold and the second threshold using handover measurement configurations received from the wireless network.

In embodiments, the method further comprises: prioritizing, in the first distribution, scan time of the serving antenna panel over the other antenna panels in response to the measured downlink quality of the serving cell being higher than the measured downlink quality of neighboring cells; prioritizing, in the second distribution, scan time of antenna panels, which provide best measurement results on one or more candidate target cells; and prioritizing, in the third distribution, scanning by an antenna panel providing best measurement results on the target cell.

In embodiments, the method further comprises: associating in the first distribution two or more first distribution levels with corresponding first level thresholds; and determining, in the first mode, the first distribution of the scan time by comparing at least a measured downlink quality value with the first level thresholds, starting from the highest first level threshold, and determine the first distribution of the scan time to be a first distribution in the level whose level threshold is met.

In embodiments, the method further comprises: associating in the second distribution two or more second distribution levels with corresponding second level thresholds; determining, in the second mode, the second distribution of the scan time by comparing a first difference calculated from measurement results with the second level thresholds, starting from the highest second level threshold; and determining the second distribution of the scan time to be a second distribution in the level whose level threshold is met.

In embodiments, the method further comprises: associating in the third distribution two or more third distribution levels with corresponding third level thresholds; determining, in the third mode, the third distribution of the scan time by comparing a second difference calculated from the measurement results with the third level thresholds, starting from the highest third level threshold; and determining the third distribution of the scan time to be a third distribution in the level whose level threshold is met.

According to an aspect there is provided a computer readable medium comprising program instructions for causing an apparatus to perform at least the following: performing, periodically during a scan time, downlink quality measurements on a serving cell and on at least one neighboring cell; determining, in a first mode, a first distribution of the scan time between a plurality of antenna panels, based on measurement results of a serving antenna panel of the plurality of antenna panels, on the serving cell; determining, in a second mode, a second distribution of the scan time between a subset of the plurality of antenna panels, based on a first difference between measurement results on the serving cell and measurement results on one or more candidate target cells for a handover procedure; and determining, in a third mode, a third distribution of the scan time between a further subset of the plurality of antenna panels, based on a second difference between measurement results on the serving cell and measurement results on a target cell.

In an embodiment, the computer readable medium is a non-transitory computer readable medium.

According to an aspect there is provided a computer program comprising instructions for causing an apparatus to perform at least the following: performing, periodically during a scan time, downlink quality measurements on a serving cell and on at least one neighboring cell; determining, in a first mode, a first distribution of the scan time between a plurality of antenna panels, based on measurement results of a serving antenna panel of the plurality of antenna panels, on the serving cell; determining, in a second mode, a second distribution of the scan time between a subset of the plurality of antenna panels, based on a first difference between measurement results on the serving cell and measurement results on one or more candidate target cells for a handover procedure; and determining, in a third mode, a third distribution of the scan time between a further subset of the plurality of antenna panels, based on a second difference between measurement results on the serving cell and measurement results on a target cell.

### BRIEF DESCRIPTION OF DRAWINGS

Embodiments are described below, by way of example only, with reference to the accompanying drawings, in which

FIG. 1 illustrates an exemplified wireless communication system;

FIG. 2 illustrates an example of a moving multi-panel apparatus;

FIGS. 3 to 6 are flow charts illustrating functionalities;

FIGS. 7 and 8 illustrate examples of handover procedures; and

FIG. 9 is a schematic block diagram.

### DETAILED DESCRIPTION OF SOME EMBODIMENTS

The following embodiments are examples. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may contain also features/structures that have not been specifically mentioned. Further, although terms including ordinal numbers, such as “first”, “second”, etc., may be used for describing various elements, the structural elements are not restricted by the terms. The terms are used merely for the purpose of distinguishing an element from other elements. For example, a first signal could be termed a second signal, and similarly, a second signal could be also termed a first signal without departing from the scope of the present disclosure.

In the following, different exemplifying embodiments will be described using, as an example of an access architecture to which the embodiments may be applied, a radio access architecture based on long term evolution advanced (LTE Advanced, LTE-A) or new radio (NR, 5G), without restricting the embodiments to such an architecture, however. The embodiments may also be applied to other kinds of communications networks having suitable means by adjusting parameters and procedures appropriately. Some examples of other options for suitable systems are the universal mobile telecommunications system (UMTS) radio access network (UTRAN or E-UTRAN), long term evolution (LTE, the same as E-UTRA), wireless local area network (WLAN or WiFi), worldwide interoperability for microwave access (WiMAX), Bluetooth®, personal communications services (PCS), ZigBee®, wideband code division multiple access (WCDMA), systems using ultrawideband (UWB) technology, sensor networks, mobile ad-hoc networks (MANETs) and Internet Protocol multimedia subsystems (IMS) or any combination thereof.

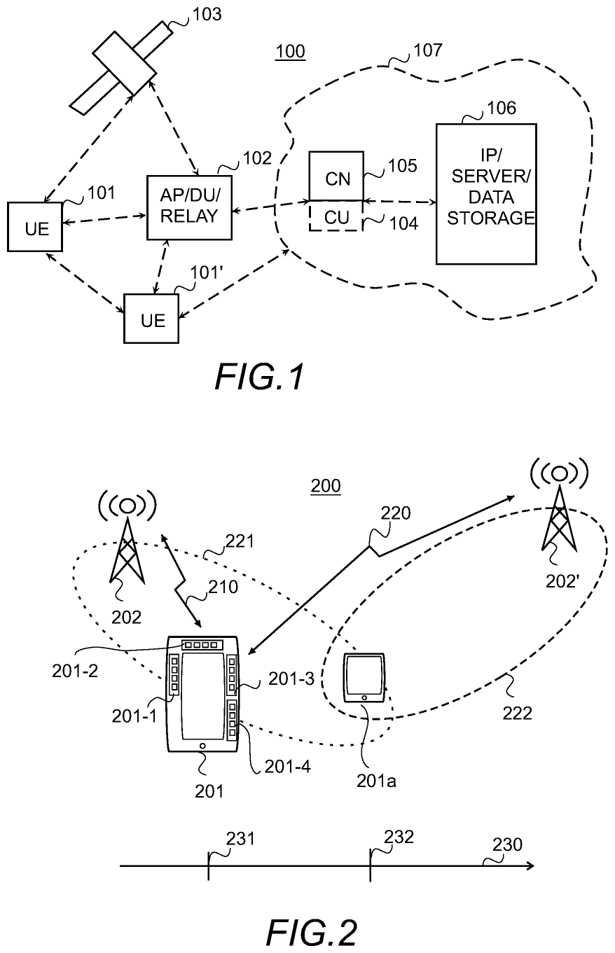

FIG. 1 depicts examples of simplified system architectures only showing some elements and functional entities, all being logical units, whose implementation may differ from what is shown. The connections shown in FIG. 1 are logical connections; the actual physical connections may be different. It is apparent to a person skilled in the art that the system typically comprises also other functions and structures than those shown in FIG. 1.

The embodiments are not, however, restricted to the system 100 given as an example but a person skilled in the art may apply the solution to other communication systems provided with necessary properties.

The example of FIG. 1 shows a part of an exemplifying radio access network.

FIG. 1 shows user devices 101, 101′ configured to be in a wireless connection on one or more communication channels with a node 102. The node 102 is further connected to a core network 105. In one example, the node 102 may be an access node such as (e/g)NodeB providing or serving devices in a cell. In one example, the node 102 may be a non-3GPP access node. The physical link from a device to a (e/g)NodeB is called uplink or reverse link and the physical link from the (e/g)NodeB to the device is called downlink or forward link. It should be appreciated that (e/g)NodeBs or their functionalities may be implemented by using any node, host, server or access point etc. entity suitable for such a usage.

A communications system typically comprises more than one (e/g)NodeB in which case the (e/g)NodeBs may also be configured to communicate with one another over links, wired or wireless, designed for the purpose. These links may be used for signalling purposes. The (e/g)NodeB is a computing device configured to control the radio resources of communication system it is coupled to. The NodeB may also be referred to as a base station, an access point or any other type of interfacing device including a relay station capable of operating in a wireless environment. The (e/g)NodeB includes or is coupled to transceivers. From the transceivers of the (e/g)NodeB, a connection is provided to an antenna unit that establishes bi-directional radio links to devices. The antenna unit may comprise a plurality of antennas or antenna elements. The (e/g)NodeB is further connected to the core network 105 (CN or next generation core NGC). Depending on the system, the counterpart on the CN side can be a serving gateway (S-GW, routing and forwarding user data packets), packet data network gateway (P-GW), for providing connectivity of user devices (UEs) to external packet data networks, or mobile management entity (MME), or access and mobility management function (AMF), etc.

The user device (also called UE, user equipment, user terminal, terminal device, etc.) illustrates one type of an apparatus to which resources on the air interface are allocated and assigned, and thus any feature described herein with a user device may be implemented with a corresponding apparatus, such as a relay node. An example of such a relay node is a layer 3 relay (self-backhauling relay) towards the base station.

The user device typically refers to a device (e.g. a portable or non-portable computing device) that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a device may also be a nearly exclusive uplink only device, of which an example is a camera or video camera loading images or video clips to a network. A device may also be a device having capability to operate in Internet of Things (IoT) network which is a scenario in which objects are provided with the ability to transfer data over a network without requiring human-to-human or human-to-computer interaction, e.g. to be used in smart power grids and connected vehicles. The user device may also utilise cloud. In some applications, a user device may comprise a user portable device with radio parts (such as a watch, earphones, eyeglasses, other wearable accessories or wearables) and the computation is carried out in the cloud. The device (or in some embodiments a layer 3 relay node) is configured to perform one or more of user equipment functionalities. The user device may also be called a subscriber unit, mobile station, remote terminal, access terminal, user terminal or user equipment (UE) just to mention but a few names or apparatuses.

Various techniques described herein may also be applied to a cyber-physical system (CPS) (a system of collaborating computational elements controlling physical entities). CPS may enable the implementation and exploitation of massive amounts of interconnected ICT devices (sensors, actuators, processors micro-controllers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented.

5G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications supports a wide range of use cases and related applications including video streaming, augmented reality, different ways of data sharing and various forms of machine type applications (such as (massive) machine-type communications (mMTC), including vehicular safety, different sensors and real-time control. 5G is expected to have multiple radio interfaces, namely below 6 GHz, cmWave and mmWave, and also being integrable with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 6 GHz-cmWave, below 6 GHz-cmWave-mmWave). One of the concepts considered to be used in 5G networks is network slicing in which multiple independent and dedicated virtual sub-networks (network instances) may be created within the same infrastructure to run services that have different requirements on latency, reliability, throughput and mobility.

The current architecture in LTE networks is fully distributed in the radio and fully centralized in the core network. The low latency applications and services in 5G require to bring the content close to the radio which leads to local break out and multi-access edge computing (MEC). 5G enables analytics and knowledge generation to occur at the source of the data. This approach requires leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system is also able to communicate with other networks, such as a public switched telephone network or the Internet 106, or utilise services provided by them. The communication network may also be able to support the usage of cloud services, for example at least part of core network operations may be carried out as a cloud service (this is depicted in FIG. 1 by “cloud” 107). The communication system may also comprise a central control entity, or a like, providing facilities for networks of different operators to cooperate for example in spectrum sharing.

The technology of Edge cloud may be brought into a radio access network (RAN) by utilizing network function virtualization (NVF) and software defined networking (SDN). Using the technology of edge cloud may mean access node operations to be carried out, at least partly, in a server, host or node operationally coupled to a remote radio head or base station comprising radio parts. It is also possible that node operations will be distributed among a plurality of servers, nodes or hosts. Application of cloudRAN architecture enables RAN real time functions being carried out at the RAN side (in a distributed unit, DU 102) and non-real time functions being carried out in a centralized manner (in a centralized unit, CU 104).

It should also be understood that the distribution of labour between core network operations and base station operations may differ from that of the LTE or even be non-existent. Some other technology advancements probably to be used are Big Data and all-IP, which may change the way networks are being constructed and managed. 5G (or new radio, NR) networks are being designed to support multiple hierarchies, where MEC servers can be placed between the core and the base station or nodeB (gNB). It should be appreciated that MEC can be applied in 4G networks as well.

5G may also utilize satellite communication to enhance or complement the coverage of 5G service, for example by providing backhauling. Possible use cases are providing service continuity for machine-to-machine (M2M) or Internet of Things (IoT) devices or for passengers on board of vehicles, or ensuring service availability for critical communications, and future railway/maritime/aeronautical communications. Satellite communication may utilise geostationary earth orbit (GEO) satellite systems, but also low earth orbit (LEO) satellite systems, in particular mega-constellations (systems in which hundreds of (nano) satellites are deployed). Each satellite 103 in the mega-constellation may cover several satellite-enabled network entities that create on-ground cells. The on-ground cells may be created through an on-ground relay node 102 or by a gNB located on-ground or in a satellite.

It is obvious for a person skilled in the art that the depicted system is only an example of a part of a radio access system and in practice, the system may comprise a plurality of (e/g)NodeBs, the user device may have an access to a plurality of radio cells and the system may comprise also other apparatuses, such as physical layer relay nodes or other network elements, etc. At least one of the (e/g)NodeBs or may be a Home(e/g)nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometers, or smaller cells such as micro-, femto- or picocells. The (e/g)NodeBs of FIG. 1 may provide any kind of these cells. A cellular radio system may be implemented as a multilayer network including several kinds of cells. Typically, in multilayer networks, one access node provides one kind of a cell or cells, and thus a plurality of (e/g)NodeBs are required to provide such a network structure.

For fulfilling the need for improving the deployment and performance of communication systems, the concept of “plug-and-play” (e/g)NodeBs has been introduced. Typically, a network which is able to use “plug-and-play” (e/g)Node Bs, includes, in addition to Home(e/g)NodeBs (H(e/g)nodeBs), a home node B gateway, or HNB-GW (not shown in FIG. 1). A HNB Gateway (HNB-GW), which is typically installed within an operator's network may aggregate traffic from a large number of HNBs back to a core network.

In 5G and beyond, it is envisaged that mobile smart device based services would become more and more popular. A non-limiting list of examples of such mobile smart devices and services include unmanned mobility with fully autonomous connected vehicles, other vehicle-to-everything (V2X) services, or smart industry with different Industrial Internet of Things (IIoT) devices, such as automated guided vehicles or mobile robots or mobile robot arms. Below term mobile apparatus is used to cover all kind of user devices, that can move, including the above listed examples without limiting mobile apparatuses to the listed examples.

FIG. 2 provides a highly simplified example of a moving mobile apparatus.

Referring to FIG. 2, a mobile apparatus (depicted by two apparatus blocks 201, 201a) is moving (230) in a wireless access network 200, which in the illustrated example is provided by means of base stations 202, 202′ (for example, gNBs, access nodes, transmission-reception points, or other network apparatuses) via corresponding cells 221, 222, as described above with FIG. 1. It should be appreciated, even though not illustrated in FIG. 2 for the sake of clarity, that a cell may comprise a plurality of beams, wherein a wireless connection may be via one beam. When the mobile apparatus moves from location 231 (the mobile apparatus is depicted in the location with a bigger apparatus block 201) to a location 232 (the mobile apparatus is depicted in the location with a smaller apparatus block 201a), a handover from the cell 221 to cell 222 may be triggered, based on downlink quality measurements on a serving cell and on at least one neighboring cell. The radio network 200, for example the serving base station 202, configures the mobile apparatus with downlink quality measurement procedures, including when to report measurement results. For example, the mobile apparatus may be configured to measure reference signals received power (RSRP) on layer 1 and/or on layer 3, and/or reference signals received quality (RSRQ) on layer 3, and/or signal interference+noise ratio (SINR) on layer 1.

5G supports at least three different types of handovers, the types being baseline handover, conditional handover (CHO) and dual active protocol stack (DAPS) handover. During a handover procedure a mobile apparatus is handed over from a source cell (source access node) to a target cell (target access node). The source cell is a serving cell before the handover, and the target cell is the serving cell after the handover. During a handover procedure the source cell prepares at least one target cell. In the baseline handover, the mobile apparatus 201 releases its connection to the source cell 221 before a connection is established with the target cell 222. Due to this there is a short interruption in the communication. In the dual active protocol stack handover, the mobile apparatus maintains its connection to the source cell 221 as an active connection to send and receive data until the mobile apparatus 201 has established another active connection with the target cell 222. Only after there is an active connection with the target cell 222, the connection to the source cell 221 is released. Hence, the mobile apparatus may simultaneously receive and transmit data from/to both the source cell and target cell for a short time period during the dual active protocol stack handover procedure. In the conditional handover the source cell may prepare, based on a measurement report received from the mobile apparatus, one or more candidate target cells for a conditional handover, and configure beforehand the mobile apparatus correspondingly with one or more conditional handover execution conditions, fulfilment of any triggers the handover to one of the candidate cells as a target cell of the handover.

In the illustrated example, the mobile apparatus 201 is a so called multi-panel user device and comprises at least one set of antenna panels (arrays) 201-1, 201-2, 201-3, 201-4 to communicate with a radio access network. Depending on an implementation, the mobile apparatus 201 may be configured to use, per a set of plurality of antenna panels, one antenna panel at a time as an active antenna panel for transmission/reception/measurements, or to use two or more antenna panels at a time as active antenna panels for transmission/reception/measurements, or to use two or more antenna panels at a time as active antenna panels for reception/measurements but only one of them as an active antenna panel for transmission. In the below examples it is assumed, for the sake of clarity of the description, that there is one set of antenna panels, and that in the set of the plurality of antenna panels, one antenna panel can at a time perform downlink quality measurements, during which measurements the other antenna panels are inactive, and one of antenna panel at a time can be a serving antenna panel for uplink and downlink data transmissions (when no other panels perform measurements). The serving antenna panel is an active antenna panel with the strongest received power on the serving cell amongst the plurality of antenna panels. For example, the antenna panel 201-2 may be a serving antenna panel providing best measurement results on the serving cell 221 in the location 231, whereas the antenna panel 201-3 may be the one providing best measurement results from the neighbouring cell 222. However, it should be appreciated that the serving antenna panel 201-2 may also be an antenna panel that is best, i.e. provides best measurement results, for the neighboring cell 222.

The multi-panel user device is configured, for example by the radio network, to perform periodically during a scan time downlink quality measurements. By distributing the scan time between the plurality of antenna panels in an adjustable way, the mobile apparatus (multi-panel user device) may optimize mobility performance.

To provide an adjustable scan time distribution between the plurality of the antenna panels the mobile apparatus may be configured to perform downlink quality measurements in one of at least three different modes. There are no limitations what values are measured to determine the quality of the downlink.

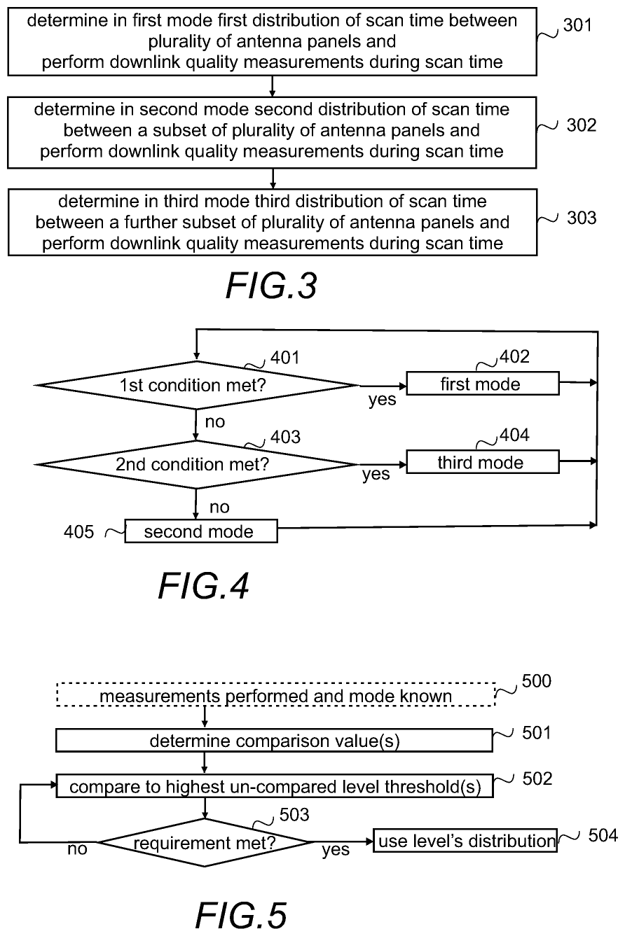

Referring to FIG. 3, in the illustrated example the mobile apparatus is configured with a first mode, a second mode and a third mode to distribute the scan time between the antenna panels, and to perform, periodically during a scan time, downlink quality measurements on a serving cell and on at least one neighboring cell.

In the first mode (block 301), a first distribution of the scan time between a plurality of antenna panels is determined based on measurement results of a serving antenna panel of the plurality of antenna panels, on the serving cell, and, during a next scan time, downlink quality measurements are performed according to the first distribution.

In the second mode (block 302), a second distribution of the scan time between a subset of the plurality of antenna panels is determined, based on a first difference between measurement results on the serving cell and measurement results on one or more candidate target cells for a handover procedure and, during a next scan time, downlink quality measurements are performed according to the second distribution.

In the third mode (block 303), a third distribution of the scan time between a further subset of the plurality of antenna panels is determined, based on a second difference between measurement results on the serving cell and measurement results on a target cell and, during a next scan time, downlink quality measurements are performed according to the second distribution.

The further subset of the plurality of antenna panels in the third mode may comprise at least some of the antenna panels of the subset of the plurality of antenna panels in the second mode.

Using the example in FIG. 2, the mobile apparatus may distribute in the first mode the scan time between the antenna panels 201-1, 201-2, 201-3, 201-4, in the second mode between the antenna panels 201-2, 201-3, 201-4, and in the third mode between the antenna panels 201-2 and 201-3.

FIG. 4 illustrates one example how a mobile apparatus may determine the mode in which it is. Referring to FIG. 4, the mobile apparatus is in the first mode (block 402) when a first condition is met (block 401: yes), in the third mode (block 404) when the first condition is not met and a second condition is met (block 401: no, block 403: yes) and in the second mode (block 405) when the first condition and the second condition are not met (block 401: no, block 403: no).

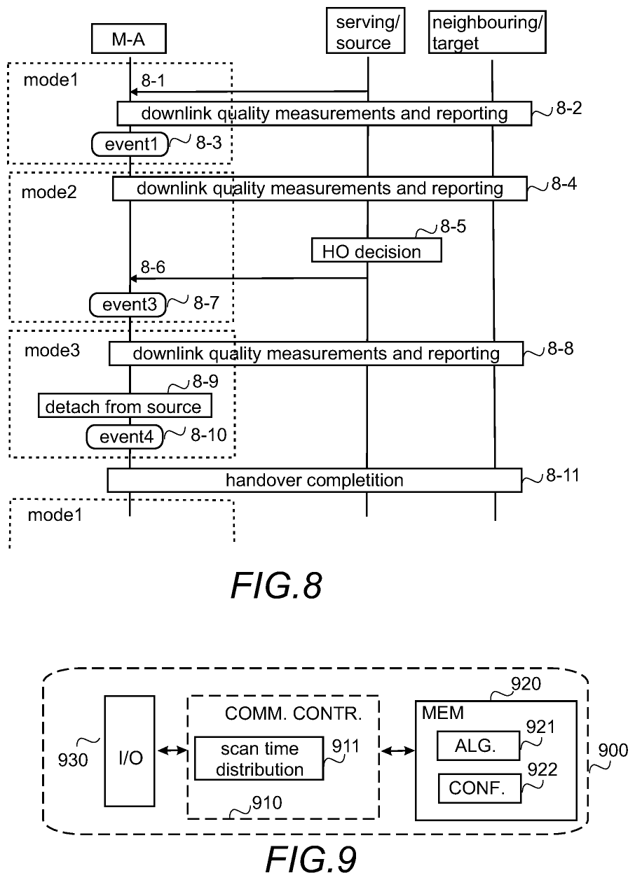

In an implementation, the first condition is met, when a difference between a measurement result on the serving cell and a best measurement result on neighboring cells is not below a first threshold. The first threshold may have a value that is higher than or equal to a threshold value that may initiate a handover procedure. In the implementation, the second condition is met, when the mobile apparatus has received information that at least a target cell is prepared for the handover and a difference between a measurement result on the serving cell and a best measurement result on the target cell, or a best measurement result on candidate target cells is below a second threshold. The second threshold may be equal to or smaller than the first threshold. Further examples when the first condition is met and/or the second condition is met, are given below with FIGS. 7 and 8 by means of different events.

Depending on an implementation, the first distribution and/or the second distribution and/or the third distribution may be using different distribution levels (intervals), a distribution level being associated with one more level thresholds. The level thresholds may be internal configurations of the mobile apparatus, or may be received from the radio access network or may be a combination of internal configurations and received configurations. For example, configurations received from the radio access network for handover preparation and/or for handover triggering may be used to determine one or more of the level thresholds, or the configurations may contain the level thresholds.

Referring to FIG. 5, after downlink quality measurements have been performed (block 500) and the mode is known (block 500), one or more comparison values are determined in block 501. Then the one or more comparison values are compared in block 502 to the highest one of one or more un-compared level thresholds. It is checked in block 503, whether the one or more comparison values meets requirement(s) defined by the one or more thresholds. If the requirement(s) are met (block 503: yes), then the level's scan time distribution is used (block 504) as the next scan time distribution. Otherwise (block 503: no), the process returns to block 502 to take the highest one or more un-compared level thresholds.

In the following, non-limiting examples, it is assumed that the mobile apparatus measures, as part of downlink quality measurements, at least reference signals received power (RSRP) and/or signal interference+noise ratio (SINR).

In an example, in the first mode, measured RSRP and SINR on the serving cell are determined in block 501 to be comparison values. Then the comparison values are compared (block 502) to a first level's (highest level) level thresholds, and if the comparison values are above (503) the level thresholds, the first level's distribution is used as the first distribution. If the comparison values are not above the first level's thresholds, the comparison values are then compared (block 502) to a second level's thresholds, etc. In another example, measured RSRP on the serving cell is used as a comparison value. In further examples, one or more of the comparison values may be any values indicating downlink quality, for example modulation and coding scheme used, channel quality indicator, etc.

Still a further example in the first mode, illustrated in the table below, uses SINR as the comparison value, and has three levels with corresponding levels' distributions (first distributions), associated with level thresholds. It should be appreciated that any number of levels may be used.

| level | level threshold(s) | level's distribution |
|---|---|---|
| 1 | SINR > 30 dB | In round robin way 95% to serving antenna |
| | | panel, 5% to other antenna panels |
| 2 | 30 dB > SINR > 15 dB | In round robin way 80% to serving antenna |
| | | panel, 20% to other antenna panels |
| 3 | 15 dB > SINR > 5 dB | In round robin way 50% to serving antenna |
| | | panel, 50% to other antenna panels |

It should be appreciated that it is possible to allocate all the scan time, i.e. 100%, to the serving antenna panel, when the measurement results indicate that the mobile apparatus is near the center of the cell, for example.

In an example, in the second mode, a difference between measured RSRP on the serving cell and best measured RSRP on candidate target cell(s) is determined in block 501 to be the comparison value. Then the comparison values are compared (block 502) to a first level's (highest level) level threshold, and if the comparison value is above (503) the level thresholds, the first level's distribution is used as the second distribution. If the comparison value is not above the first level's threshold, the comparison value is then compared (block 502) to a second level's threshold, etc.

An example for the second mode is illustrated in the table below. In the example, the second mode has three levels with corresponding levels' distributions (second distributions), associated with level thresholds. It should be appreciated that any number of levels may be used, and the number of levels in the second mode may also be different than the number of levels in the first mode or in the third mode (provided that the first and/or third modes have the levels).

| level | level threshold(s) | level's distribution |
|---|---|---|
| 1 | ΔRSRP > 5 dB | 50% to serving antenna panel, 50% |
| | | to antenna panels best for |
| | | candidate target cells |
| 2 | 5 dB > ΔRSRP > 0 dB | 20% to serving antenna panel, 80% |
| | | to antenna panels best for |
| | | candidate target cells |
| 3 | 0 dB > ΔRSRP | 5% to serving antenna panel, 95% |
| | | to antenna panels best for |
| | | candidate target cells |

In an example, in the third mode, a difference between measured RSRP on the serving cell and measured RSRP on the target cell is determined in block 501 to be the comparison value. Then the comparison value is compared (block 502) to a first level's (highest level) level threshold, and if the comparison value is above (503) the level thresholds, the first level's distribution is used as the second distribution. If the comparison value is not above the first level's threshold, the comparison value is then compared (block 502) to a second level's threshold, etc.

An example for the third mode is illustrated in the table below. In the example, the third mode has three levels with corresponding levels' distributions (third distributions), associated with level thresholds. It should be appreciated that any number of levels may be used, and the number of levels in the third mode may also be different than the number of levels in the first mode or in the second mode (provided that the modes have the levels).

| level | level threshold(s) | level's distribution |
|---|---|---|
| 1 | ΔRSRP > 3 dB | 50% to serving antenna panel, 50% to |
| | | antenna panel best for target cell |
| 2 | 3 dB > ΔRSRP > −1 dB | 20% to serving antenna panel, 80% to |
| | | antenna panel best for target cell |
| 3 | −1 dB > ΔRSRP | 5% to serving antenna panel, 95% to |
| | | antenna panel best for target cell |

The above mentioned difference power level on the serving cell and the best neighboring cell (which may be a candidate target cell or a target cell), ΔRSRP, may be used also when determining the mode. For example, the first condition may comprise, as one criterion, that ΔRSRP should be over a first threshold, and the second condition may comprise, as one criterion, that ΔRSRP should be over a second threshold. The first and second thresholds may be seen as mode switching thresholds that assists to proactive prioritize measurements for a handover near a cell edge. Hence, both thresholds or one of them may be determined based on handover configurations, received for example with the downlink quality measurement procedure configurations.

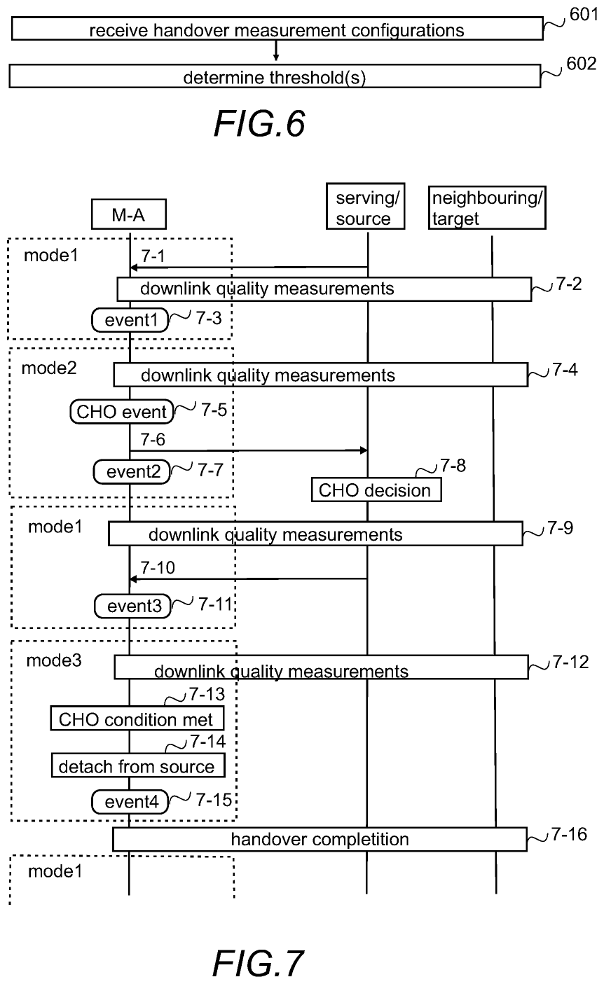

Referring to FIG. 6, when handover measurement configurations are received (block 601) from the radio access network, for example when the mobile apparatus is configured with downlink quality measurement procedures, the mobile apparatus may be configured to determine (block 602) at least the first threshold and/or the second threshold using the handover measurement configurations. For example, the mobile apparatus may be configured to determine the first threshold by adding to a cell offset parameter a first offset, preconfigured to the mobile apparatus. The mobile apparatus may be configured to determine the second threshold by adding to the cell offset parameter the first offset, or by adding to the cell offset parameter a second offset, or by deducing from the cell offset parameter the first offset or a third offset. If the mobile apparatus is configured to use the second offset, the second offset may be preconfigured to the mobile apparatus, and the value of the second offset is smaller than the value of the first offset. If the mobile apparatus is configured to use the third offset, the third offset may be preconfigured to the mobile apparatus.

It should be appreciated that in other implementations, the handover measurement configurations may comprise the first threshold and/or the second threshold and/or the first offset and/or the second offset and/or the third offset.

FIGS. 7 and 8 are flow charts illustrating information exchange and different functionalities during handover procedures in view of a mobile apparatus configured to operate in the first mode, the second mode and the third mode, FIG. 7 describing a conditional handover, FIG. 8 covering a baseline handover and a dual active protocol stack handover. Since there are no modifications to the handover procedures in the radio access network side, there is no need to describe them in detail herein. An assumption made in FIGS. 7 and 8 is that when a difference between a power level in the serving cell and a best power level measured on neighboring cells is first time below the first threshold, it will remain below the first threshold until the handover has been completed. (Whenever the difference is not below the first threshold, the first condition is met and the mobile apparatus switches back to the first mode or continues in the first mode.)

Referring to FIG. 7, the mobile apparatus (M-A) is in the first mode (mode 1) and the serving cell (serving cell access node) configures measurement procedures to the mobile apparatus by sending message 7-1. Message 7-1 may be a measurement control message. Message 7-1 contains for example values, including the cell individual offset with which the mobile apparatus can detect, from its measurement results, an event that initiates the conditional handover procedure. Depending on an implementation, the mobile apparatus may use the received information to determine the first threshold and the second threshold. For example, for each measurement M_{N}, the mobile apparatus may receive, for an eventA3 and during a certain time to trigger TTT_{HO} a condition as follows:

$${M}_{N} + {CIO}_{HO} > {M}_{S} + {off}_{HO}$$

wherein M_{N} is the measurement of the neighboring cell, M_{S} is the measurement of the serving cell, off_{HO} is an offset value (also called HO hysteresis or HO margin), and CIO_{HO} is a cell individual offset. Offset off_{HO} and/or offset CIO_{HO} may be used in determining the thresholds.

The mobile apparatus performs (block 7-2) downlink quality measurements in the first mode using a first distribution of scan time between the antenna panels per measurement, and determines, based on such measurement results, a first distribution of scan time between the antenna panels to be used as long as further downlink quality measurements are performed and until event1 is detected (block 7-3) by the mobile apparatus. The event1 is detected in the illustrated example when a difference between a power level in the serving cell and a best power level measured on neighboring cells is below the first threshold. (Referring to FIG. 4, the first condition is not any more met.) Further, in the illustrated example it is assumed that event1 causes the mobile apparatus to determine one or more candidate target cells using the first threshold.

Therefore, upon detecting event1, the mobile apparatus switches to the second mode (mode 2), and performs (block 7-4) downlink quality measurements on the one or more candidate target cells in the second mode using a second distribution of scan time between antenna panels best for the candidate target cells per measurement, and determines, based on such measurement results, a second distribution of the scan time to be used as long as further downlink quality measurements are performed and until event2 is detected (block 7-7) by the mobile apparatus. Conditional handover event is detected when conditions defined for conditional handover cell preparation event, for example eventA3, or eventA5 are satisfied for one or more candidate target cells. (Depending on an implementation, the mobile apparatus may update the candidate target cells determined when event1 was detected to be candidate target cells determined by the conditional handover event.) The event2 is detected in response to a conditional handover (CHO) event being detected (block 7-5) and a measurement report (message 7-6) being sent. In other words, the event2 is detected when the handover procedure is initiated. Referring to FIG. 4, the first condition is again met (even though a power level in the serving cell and a best power level measured on neighboring cells is below the first threshold).

Therefore, upon detecting event2, the mobile apparatus switches back to the first mode (mode 1) and performs (block 7-9) downlink quality measurements on neighboring cell in the first mode using a first distribution of scan time between the antenna panels per measurement, and determines, based on such measurement results, a first distribution of scan time to be used between the antenna panels as long as further downlink quality measurements are time performed and until event3 is detected (block 7-11) by the mobile apparatus. The event3 is detected in response to receiving from the serving cell message 7-10 informing that candidate target cells have been prepared, the message containing one or more conditional handover execution conditions, and a difference between a power level in the serving cell and a best power level measured on neighboring cells is below the second threshold. Message 7-10 may be a radio resource control (RRC) reconfiguration message. Referring to FIG. 4, when event3 happens, the first condition is not any more met, but the second condition is met. In the illustrated example, the mobile apparatus may be configured to use, as the target cell, the strongest neighboring cell measured when event3 is detected.

Therefore, upon detecting event3, the mobile apparatus switches from the first mode (mode 1) to the third mode (mode 3) and performs (block 7-12) downlink quality measurements on the target cell, i.e. in the example the neighboring cell that triggered event3, until one of the conditional handover execution conditions is met in block 7-13, and the mobile apparatus detaches from the serving cell (source), in block 7-14, causing an event4 to be detected (block 7-15). Referring to FIG. 4, when event4 is detected, the second condition is not any more met, but after the handover completion (block 7-16) the first condition is again met. Hence, after the handover has been completed, the mobile apparatus is in the first mode. In case the mobile apparatus is configured to keep the configuration of the prepared cells after the completion of the conditional handover (block 7-16) to support fallback mechanism, the mobile apparatus may continue in the third mode (mode 3) as long as event3 for the target cell is satisfied, i.e. the second condition is met after the completion of the handover, and event4 (block 7-15) may be detected when a fallback procedure ends, for example after expiry of a fallback period.

In another implementation, there is no event2, and the mobile apparatus remains in the second mode until event3 is detected, after which the mobile apparatus switches to the third mode.

Referring to FIG. 8, the mobile apparatus (M-A) is in the first mode (mode 1) and the serving cell (serving cell access node) configures measurement procedures to the mobile apparatus by sending message 8-1. Message 8-1 may be a measurement control message, for example similar to above described message 7-1.

The mobile apparatus performs (block 8-2) downlink quality measurements and reports in the first mode, using a first distribution of scan time between the antenna panels per measurement, and determines, based on such measurement results, a first distribution of scan time to be used as long as further downlink quality measurements are performed and until event1 is detected (block 8-3) by the mobile apparatus. The event1 is detected in the illustrated example when a difference between a power level in the serving cell and a best power level measured on neighboring cells is below the first threshold. (Referring to FIG. 4, the first condition is not any more met.) In the illustrated example, the mobile apparatus may be configured to use, as one or more candidate target cells, N strongest cells measured when event1 is detected.

Therefore, upon detecting event1, the mobile apparatus switches to the second mode (mode 2), and performs (block 8-4) downlink quality measurements and reports in the second mode using a second distribution of scan time between antenna panels that are best for the N strongest cells, per measurement, and determines, based on such measurement results, a second distribution of the scan time to be used as long as further downlink quality measurements are performed and until event3 is detected (block 8-7) by the mobile apparatus. In the meanwhile the serving node performs handover decision (8-5). The event3 is detected in response to both receiving from the serving cell message 8-6 informing a target cell, which has been prepared for the handover to a target, and a difference between a power level in the serving cell and a best power level measured on neighboring cells being below the second threshold. Referring to FIG. 4, when event3 happens, the second condition is met. Message 8-6 may be a radio resource control (RRC) reconfiguration message. Referring to FIG. 4, when event3 happens, the second condition is met.

Therefore, upon detecting event3, the mobile apparatus switches from the second mode (mode 2) to the third mode (mode 3) and performs (block 8-8) downlink quality measurements on the target cell until the mobile apparatus detaches in block 8-9 from the serving cell (source) for baseline handover, causing an event4 is detected (block 8-10). For dual active protocol stack handover, block 8-9 happens when the mobile apparatus switches uplink transmission to the new serving cell. Referring to FIG. 4, when event4 is detected, the second condition is not any more met, but after the handover completion (block 8-11) the first condition is again met. Hence, after the handover has been completed, the mobile apparatus is in the first mode.

The first mode may be called an intra-cell mode, the second mode an inter-cell phase 1 mode and the third mode an inter-cell phase 2 mode.

By adjusting distribution of scan times for the plurality of panels, and what antenna panels are used during the scan time as described above with the different examples, compared to a fixed distribution of scan times to all of the plurality of panels, following drawbacks may be avoided: A too late handover and a radio link failure caused by the mobile apparatus not being aware of a better cell, since the corresponding antenna panel is not activated for downlink quality measurements often enough, whereas activating the plurality of antenna panels more often for downlink quality measurements may lead to packet losses for packets scheduled in the serving cell, since another antenna panel may perform measurements when a packet is scheduled to be transmitted.

Further, the third mode enhances timely downlink quality measurements on the target cell before handover execution, or before the mobile apparatus detaching form the serving cell (source).

Even though in the above examples there was an assumption that one panel at a time can perform the downlink quality measurements, based on the present disclosure, it is a straightforward measure for one skilled in the art how to implement the disclosed examples to solutions in which two or more antenna panels can be used at a time for the downlink quality measurements while the other panels are inactive.

The blocks, related functions, and information exchanges described above by means of FIGS. 2 to 8 are in no absolute chronological order, and some of them may be performed simultaneously or in an order differing from the given one. Other functions can also be executed between them or within them, and other information may be transmitted, and/or other rules applied or selected. Some of the blocks or part of the blocks or one or more pieces of information can also be left out or replaced by a corresponding block or part of the block or one or more pieces of information.

FIG. 9 illustrate a mobile apparatus comprising a communication controller 910, such as at least one processor or processing circuitry, and at least one memory 920 including a computer program code (software, algorithm) ALG. 921, wherein the at least one memory and the computer program code (software, algorithm) are configured, with the at least one processor, to cause the mobile apparatus to carry out any one of the embodiments, examples and implementations described above. The mobile apparatus of FIG. 9 may be an electronic device, for example a multi-panel user device described with FIG. 2. Further examples are listed above with reference to FIG. 1.

Referring to FIG. 9, the memory 920 may be implemented using any suitable data storage technology, such as semiconductor based memory devices, flash memory, magnetic memory devices and systems, optical memory devices and systems, fixed memory and removable memory. The memory may comprise a configuration storage CONF. 921, such as a configuration database, for at least storing measurement configurations, including handover configurations, different distributions and conditions for mode switching. The memory 920 may further store a data buffer for data waiting to be processed (including transmission).

Referring to FIG. 9, the mobile apparatus comprises a communication interface 930 comprising hardware and/or software for realizing communication connectivity, including a plurality of antenna panels, according to one or more wireless and/or wired communication protocols. The communication interface 930 may provide the apparatus with radio communication capabilities.

Digital signal processing regarding transmission and reception of signals may be performed in a communication controller 910. The communication interface may comprise standard well-known components such as an amplifier, filter, frequency-converter, (de) modulator, and encoder/decoder circuitries and one or more antennas.

The communication controller 910 comprises a scan time distribution circuitry 911 configured at least to select distribution of scan time of antenna panels according to any one of the embodiments/examples/implementations described above. The communication controller 910 may control the scan time distribution circuitry 911. Further, the communication controller 910 may control downlink quality measurements and reporting according to and/or functionalities relating to a handover according to corresponding configurations.

In an embodiment, at least some of the functionalities of the mobile apparatus of FIG. 9 may be shared between two physically separate devices, forming one operational entity. Therefore, the apparatus may be seen to depict the operational entity comprising one or more physically separate devices for executing at least some of the processes described above.

As used in this application, the term ‘circuitry’ refers to all of the following: (a) hardware-only circuit implementations, such as implementations in only analog and/or digital circuitry, and (b) combinations of circuits and soft-ware (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present. This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

In an embodiment, at least some of the processes described in connection with FIGS. 2 to 8 may be carried out by an apparatus comprising corresponding means for carrying out at least some of the described processes. The apparatus may comprise separate means for separate phases of a process, or means may perform several phases or the whole process. Some example means for carrying out the processes may include at least one of the following: detector, processor (including dual-core and multiple-core processors), digital signal processor, controller, receiver, transmitter, encoder, decoder, memory, RAM, ROM, software, firmware, display, user interface, display circuitry, user interface circuitry, user interface software, display software, circuit, antenna, antenna circuitry, and circuitry. In an embodiment, the at least one processor, the memory, and the computer program code form processing means or comprises one or more computer program code portions for carrying out one or more operations according to any one of the embodiments/examples/implementations described herein.

According to yet another embodiment, the apparatus carrying out the embodiments/examples comprises a circuitry including at least one processor and at least one memory including computer program code. When activated, the circuitry causes the apparatus to perform at least some of the functionalities according to any one of the embodiments/examples/implementations of FIGS. 2 to 8, or operations thereof.

The techniques and methods described herein may be implemented by various means. For example, these techniques may be implemented in hardware (one or more devices), firmware (one or more devices), software (one or more modules), or combinations thereof. For a hardware implementation, the apparatus may be implemented within one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. For firmware or software, the implementation can be carried out through modules of at least one chip set (e.g. procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the mobile apparatus described herein may be rearranged and/or complemented by additional components in order to facilitate the achievements of the various aspects, etc., described with regard thereto, and they are not limited to the precise configurations set forth in the given figures, as will be appreciated by one skilled in the art.

Embodiments/examples/implementations as described may also be carried out in the form of a computer process defined by a computer program or portions thereof. Embodiments of the methods described in connection with FIGS. 2 to 8 may be carried out by executing at least one portion of a computer program comprising corresponding instructions. The computer program may be in source code form, object code form, or in some intermediate form, and it may be stored in some sort of carrier, which may be any entity or device capable of carrying the program. For example, the computer program may be stored on a computer program distribution medium readable by a computer or a processor. The computer program medium may be, for example but not limited to, a record medium, computer memory, read-only memory, electrical carrier signal, telecommunications signal, and software distribution package, for example. The computer program medium may be a non-transitory medium, for example. Coding of software for carrying out the embodiments as shown and described is well within the scope of a person of ordinary skill in the art. In an embodiment, a computer-readable medium comprises said computer program.

It will be obvious to a person skilled in the art that, as technology advances, the inventive concept may be implemented in various ways. The embodiments are not limited to the exemplary embodiments described above, but may vary within the scope of the claims. Therefore, all words and expressions should be interpreted broadly, and they are intended to illustrate, not to restrict, the exemplary embodiments.

1-30. (canceled)

31. An apparatus comprising
at least one processor; and
at least one memory including computer program code, the at least one memory and computer program code configured to, with the at least one processor, cause the apparatus to at least:
perform, periodically during a scan time, downlink quality measure-ments on a serving cell and on at least one neighboring cell;
determine, in a first mode, a first distribution of the scan time be-tween a plurality of antenna panels, based on measurement results of a serving antenna panel of the plurality of antenna panels, on the serving cell;
determine, in a second mode, a second distribution of the scan time between a subset of the plurality of antenna panels, based on a first difference between measurement results on the serving cell and measurement results on one or more candidate target cells for a handover procedure; and
determine, in a third mode, a third distribution of the scan time be-tween a further subset of the plurality of antenna panels, based on a second difference between measurement results on the serving cell and measurement results on a target cell.

32. The apparatus of claim 31, wherein the apparatus is in the first mode at least in response to a first condition being met, the apparatus is in the second mode in response to the first condition not being met, and the apparatus is in the third mode in response to a second condition being met.

33. The apparatus of claim 32, wherein the first condition is met in response to a third difference between measurement results on the serving cell and on neighboring cells being equal to or above a first threshold, the first threshold being higher than or equal to a threshold sufficient for initiating the handover procedure.

34. The apparatus of claim 32, wherein the second condition is met at least in response to: receiving information that the target cell is prepared for the handover:
the second difference is below a second threshold, which is equal to or smaller than the first threshold; and
the serving cell is usable for uplink and downlink data transmissions.

35. The apparatus of claim 33, wherein the at least one memory and computer program code are configured to, with the at least one processor, further cause the apparatus to at least:
switch from the second mode to the first mode in response to the handover procedure having been initiated.

36. The apparatus of claim 35, wherein the at least one memory and computer program code are configured to, with the at least one processor, further cause the apparatus to at least:
remain in the first mode after switching at least until receiving from the wireless network information indicating that one or more target cells are prepared,
wherein the first threshold is higher than the threshold causing the handover to be initiated.

37. The apparatus of claim 31, wherein the at least one memory and computer program code are configured to, with the at least one processor, further cause the apparatus to at least:
determine the first threshold and the second threshold using handover measurement configurations received from the wireless network.

38. The apparatus of claim 31, wherein the apparatus is configured to:
prioritize, in the first distribution, scan time of the serving antenna panel over the other antenna panels in response to the measured downlink quality of the serving cell being higher than the measured downlink quality of neighboring cells;
prioritize, in the second distribution, scan time of antenna panels, which provide best measurement results on one or more candidate target cells; and
prioritize, in the third distribution, scanning by an antenna panel providing best measurement results on the target cell.

39. The apparatus of claim 31, wherein the apparatus is configured to:
in the first distribution, allocate from at least 50 percent to 100 per-cent of the scan time to the serving antenna panel.

40. The apparatus of claim 31, wherein the apparatus is configured to:
in the second distribution, allocate from at least 5 percent to at most 50 percent of the scan time to the serving antenna panel.

41. The apparatus of claim 31, wherein the apparatus is configured to:
in the third distribution, allocate from at least 5 percent to at most 50 percent of the scan time to the serving antenna panel.

42. The apparatus of claim 31, wherein the at least one memory and computer program code are configured to, with the at least one processor, further cause the apparatus to at least:
associate in the first distribution two or more first distribution levels with corresponding first level thresholds; and
determine, in the first mode, the first distribution of the scan time by comparing at least a measured downlink quality value with the first level thresh-olds, starting from the highest first level threshold, and determine the first distribution of the scan time to be a first distribution in the level whose level threshold is met.

43. The apparatus of claim 31, wherein the at least one memory and computer program code are configured to, with the at least one processor, further cause the apparatus to at least:
associate in the second distribution two or more second distribution levels with corresponding second level thresholds;
determine, in the second mode, the second distribution of the scan time by comparing a first difference calculated from measurement results with the second level thresholds, starting from the highest second level threshold; and
determine the second distribution of the scan time to be a second distribution in the level whose level threshold is met.

44. The apparatus of claim 31, wherein the at least one memory and computer program code are configured to, with the at least one processor, further cause the apparatus to at least:
associate in the third distribution two or more third distribution levels with corresponding third level thresholds;
determine, in the third mode, the third distribution of the scan time by comparing a second difference calculated from the measurement results with the third level thresholds, starting from the highest third level threshold; and
determine the third distribution of the scan time to be a third distribution in the level whose level threshold is met.

45. A method comprising:
performing, periodically during a scan time, downlink quality measurements on a serving cell and on at least one neighboring cell;
determining, in a first mode, a first distribution of the scan time be-tween a plurality of antenna panels, based on measurement results of a serving antenna panel of the plurality of antenna panels, on the serving cell;
determining, in a second mode, a second distribution of the scan time between a subset of the plurality of antenna panels, based on a first difference between measurement results on the serving cell and measurement results on one or more candidate target cells for a handover procedure; and
determining, in a third mode, a third distribution of the scan time be-tween a further subset of the plurality of antenna panels, based on a second difference between measurement results on the serving cell and measurement results on a target cell.

46. The method of claim 45, the method further comprising:
being in the first mode at least in response to a first condition being met;
being in the second mode in response to the first condition not being met; and
being in the third mode in response to a second condition being met.

47. The method of claim 45, the method further comprising:
determining the first threshold and the second threshold using hand-over measurement configurations received from the wireless network.

48. The method of claim 45, the method further comprising:
prioritizing, in the first distribution, scan time of the serving antenna panel over the other antenna panels in response to the measured downlink quality of the serving cell being higher than the measured downlink quality of neighboring cells;
prioritizing, in the second distribution, scan time of antenna panels, which provide best measurement results on one or more candidate target cells; and
prioritizing, in the third distribution, scanning by an antenna panel providing best measurement results on the target cell.

49. A non-transitory computer readable medium comprising program instructions for causing an apparatus to perform at least the following:
performing, periodically during a scan time, downlink quality measurements on a serving cell and on at least one neighboring cell;
determining, in a first mode, a first distribution of the scan time be-tween a plurality of antenna panels, based on measurement results of a serving antenna panel of the plurality of antenna panels, on the serving cell;
determining, in a second mode, a second distribution of the scan time between a subset of the plurality of antenna panels, based on a first difference between measurement results on the serving cell and measurement results on one or more candidate target cells for a handover procedure; and
determining, in a third mode, a third distribution of the scan time be-tween a further subset of the plurality of antenna panels, based on a second difference between measurement results on the serving cell and measurement results on a target cell.

50. A computer program comprising instructions for causing an apparatus to perform at least the following:
performing, periodically during a scan time, downlink quality measurements on a serving cell and on at least one neighboring cell;
determining, in a first mode, a first distribution of the scan time be-tween a plurality of antenna panels, based on measurement results of a serving antenna panel of the plurality of antenna panels, on the serving cell;
determining, in a second mode, a second distribution of the scan time between a subset of the plurality of antenna panels, based on a first difference between measurement results on the serving cell and measurement results on one or more candidate target cells for a handover procedure; and
determining, in a third mode, a third distribution of the scan time be-tween a further subset of the plurality of antenna panels, based on a second difference between measurement results on the serving cell and measurement results on a target cell.
